(19) United States
(12) Patent Application Publication
(10) Pub. No.: US 2025/0217517 A1
(43) Pub. Date: Jul. 3, 2025

(54) Method and Device for Operating an Automation System

(71) Applicant: Siemens Aktiengesellschaft, München (DE)

(72) Inventor: Rainer Falk, Erding (DE)

(73) Assignee: Siemens Aktiengesellschaft, München (DE)

(21) Appl. No.: 18/848,854

(22) PCT Filed: Mar. 6, 2023
(86) PCT No.: PCT/EP2023/055532

§ 371 Date: Sep. 19, 2024

(30) Foreign Application Priority Data
Mar. 23, 2022 (EP) 22163896.8

(51) Int. Cl. G06F 21/64; G06F 21/62

(52) U.S. Cl. CPC G06F 21/64; G06F 21/6218

(57) ABSTRACT

Various embodiments of the teacings herein include a method for operating an automation system including a first number of I/O modules, a number of actuator/sensor devices coupled to the respective I/O module, a computer system coupled to the number of I/O modules via a network, and a second number of virtualized automation units. An example includes: providing a cryptographically protected attestation for indicating an authenticated communication connection between a specified I/O module and a specified virtualized automation unit; and checking the provided cryptographically protected attestation to determine authorization information depending on the access by the specified virtualized automation unit to the specified I/O module and/or to the at least one portion of the actuator/sensor devices coupled to the specified I/O module, said access being confirmed by the checked attestation.

### CROSS-REFERENCE TO RELATED APPLICATIONS

This application is a U.S. National Stage Application of International Application No. PCT/EP2023/055532 filed Mar. 6, 2023, which designates the United States of America, and claims priority to EP Application Serial No. 22163896.8 filed Mar. 23, 2022, the contents of which are hereby incorporated by reference in their entirety.

### TECHNICAL FIELD

The present disclosure relates to automation systems. Various embodiments of the teachings herein include method and computer program products for operating an automation system.

### BACKGROUND

In the future, automation functions will increasingly be realized in a virtualized manner in automation systems. The computer platform used in this context may in this context be under the control of the operator of the automation system itself, but computer platforms or computer infrastructures operated and thus controlled by third parties may also be used.

In a cyber-physical system (CPS), the interface between virtual environment and real, physical environment is realized by an actuator/sensor device. In this context, a virtualized automation function, such as e.g. a virtualized control unit or a virtualized PLC (PLC; programmable logic controller), is realized for example as a virtual machine or as a container which can access the actuator/sensor device via a communication network to influence the real environment of the automation system or in order to acquire information pertaining to the real environment of the automation system. If however, as explained above, the computer platform or computer infrastructure used for this purpose may also be operated by third parties, then increased security precautions are necessary. Particularly if, as explained above, a computer platform on which automation functions for the automation system are executable is operated by third parties, then measures of increased manipulation protection are required.

### SUMMARY

Against this background, the teachings of the present disclosure may be used to improve the operation of an automation system. For example, some embodiments include a method for operating an automation system (1) which comprises a first number of I/O modules (2), a number of actuator/sensor devices (3) being coupled to the respective I/O module (2), and a computer system (5) which is coupled to the number of I/O modules (2) via a network (4) and has a second number of virtualized automation units (6), the method comprising: a) providing (S1) a cryptographically protected attestation (AT) for indicating an authenticated communication connection (KV) between a specified I/O module (2) of the first number and a specified virtualized automation unit (6) of the second number, the authenticated communication connection (KV) comprising an authenticated communication between the specified virtualized automation unit (6) and the specified I/O module (2) and at least one portion of the actuator/sensor devices (3) coupled to the specified I/O module (2), and b) checking (S2) the provided cryptographically protected attestation (AT) in order to determine authorization information (BI) depending on the access by the specified virtualized automation unit (6) to the specified I/O module (2) and/or to the at least one portion of the actuator/sensor devices (3) coupled to the specified I/O module (2), said access being confirmed by the checked attestation (AT).

In some embodiments, the authorization information (BI) is adapted depending on the checking of the provided cryptographically protected attestation (AT).

In some embodiments, adapting the authorization information (BI) comprises: registering the specified virtualized automation unit (6) at the automation system (1), enabling an issuing of a digital certificate for the specified virtualized automation unit (6), and/or enabling an access for the specified virtualized automation unit (6) to a specified database of the automation system (1) and/or to a specified backend system of the automation system (1).

In some embodiments, the first number of I/O modules (2) and the actuator/sensor devices (3) are arranged in a control network (7) for controlling automation components of the automation network (1), and the computer system (5) is arranged in a network (8) superordinate to the control network (7), in particular a factory network.

In some embodiments, the cryptographically protected attestation (AT) comprises up-to-date status information for indicating an up-to-date status of the authenticated communication connection (KV) between the specified I/O module (2) and the specified virtualized automation unit (6).

In some embodiments, a) comprises: issuing the attestation (AT) by way of the specified I/O module (2), and cryptographically protecting the issued attestation (AT) by way of the specified I/O module (2).

In some embodiments, a) comprises: issuing the attestation (AT) by way of a component, in particular a hardware component, of the computer system (5), and cryptographically protecting the issued attestation (AT) by way of a component, in particular a hardware component, of the computer system (5).

In some embodiments, b) comprises: checking a specified type of the access by the specified virtualized automation unit (6) to the at least one portion of the actuator/sensor devices (3) coupled to the specified I/O module (2).

In some embodiments, b) (S2) is carried out repeatedly, in particular repeatedly according to a predetermined pattern, during ongoing operative operation of the automation system (1).

In some embodiments, a start-up functionality of a machine of the automation system (1) that is controlled by the specified virtualized automation unit (6) is enabled depending on the provided authorization information (BI), in particular is enabled exclusively when the authorization information (BI) is present.

In some embodiments, b) (S2) is carried out by a checking unit (12) separate from the first number of I/O modules (2) and from the computer system (5).

In some embodiments, the attestation (AT) is embodied as an independent data structure, in particular as an XML data structure or as a JSON data structure, which is protected by a cryptographic checksum, or the attestation (AT) is embodied as a verifiable credential or as a verifiable presentation.

In some embodiments, a) (S1) is carried out for a multiplicity of authenticated communication connections (KV) between a respective I/O module (2) and a respective virtualized automation unit (6) for providing a multiplicity of cryptographically protected attestations (AT), the multiplicity of provided cryptographically protected attestations (AT) being stored in a database (13), and step b) (S2) of checking is carried out using checking routines, the checking routines being formed by a stored procedure of the database (13) or by a smart contract of a distributed cryptographically protected transaction database.

In some embodiments, there is a computer program product which causes one or more of the methods as described herein to be carried out on a program-controlled apparatus.

As another example, some embodiments include a device for operating an automation system (1) which comprises a first number of I/O modules (2), a number of actuator/sensor devices (3) being coupled to the respective I/O module (2), and a computer system (5) which is coupled to the number of I/O modules (2) via a network (4) and has a second number of virtualized automation units (6), the device comprising: a providing unit (10) for providing a cryptographically protected attestation (AT) for indicating an authenticated communication connection (KV) between a specified I/O module (2) of the first number and a specified virtualized automation unit ((6) of the second number, the authenticated communication connection (KV) comprising an authenticated communication between the specified virtualized automation unit (6) and the specified I/O module (2) and at least one portion of the actuator/sensor devices (3) coupled to the specified I/O module (2), and a checking unit (12) for checking the provided cryptographically protected attestation (AT) in order to determine authorization information (BI) depending on the access by the specified virtualized automation unit (6) to the specified I/O module (2) and/or to the at least one portion of the actuator/sensor devices (3) coupled to the specified I/O module (2), said access being confirmed by the checked attestation (AT).

As another example, some embodiments include an automation system (1) having a first number of I/O modules (2), a number of actuator/sensor devices (3) being coupled to the respective I/O module (2), and a computer system (5) which is coupled to the number of I/O modules (2) via a network (4) and has a second number of virtualized automation units (6), and a device for operating the automation system (1) as claimed in claim 15.

### BRIEF DESCRIPTION OF THE DRAWINGS

Further advantageous configurations and aspects of the teachings herein are the subject matter of the dependent claims and of the exemplary embodiments described below. The teachings are explained in greater detail hereinafter on the basis of example embodiments with reference to the accompanying figures.

FIG. 1 shows a schematic flowchart of an example method for operating an automation system incorporating teachings of the present disclosure;

FIG. 2 shows a schematic block diagram of an example automation system incorporating teachings of the present disclosure;

FIG. 3 shows the embodiment of the automation system according to FIG. 2 with a depicted authenticated communication connection and depicted information flows incorporating teachings of the present disclosure; and

FIG. 4 shows a schematic block diagram of an example I/O module incorporating teachings of the present disclosure.

### DETAILED DESCRIPTION

Some embodiments of the teachings herein include a method for operating an automation system which comprises a first number of I/O modules and a computer system which is coupled to the first number of I/O modules via a network and has a second number of virtualized automation units. In this case, a respective number of actuator/sensor devices are coupled to the respective I/O module. The method comprises: a) providing a cryptographically protected attestation for indicating an authenticated communication connection between a specified I/O module of the first number and a specified virtualized automation unit of the second number, the authenticated communication connection comprising an authenticated communication between the specified virtualized automation unit and the specified I/O module and at least one portion of the actuator/sensor devices coupled to the specified I/O module, and b) checking the provided cryptographically protected attestation in order to determine authorization information depending on the access by the specified virtualized automation unit to the specified I/O module and/or to the at least one portion of the actuator/sensor devices coupled to the specified I/O module, said access being confirmed by the checked attestation.

The determined authorization information can be assigned to the specified virtualized automation unit. The virtualized automation unit is configured for executing at least one automation function or automation control function. The automation unit may also be referred to as automation function. Accordingly, the virtualized automation unit may also be referred to as virtualized automation function.

The use of the present attestation and the checking thereof in order to provide the authorization information enables reliable and manipulation-protected monitoring of whether a specified virtualized automation unit actually has the required access to a specified I/O module and/or the actuator/sensor devices coupled to the I/O module. If the required access is not present, however, for example a machine start-up or a security autoconfiguration, such as onboarding or provisioning, is not enabled. In the present case, therefore, the attestation indicates that between the endpoints of the authenticated communication connection, in the present case the specified I/O module and the specified virtualized automation unit, there is an authenticated communication relationship which allows or enables access to the actuator/sensor devices coupled to the specified I/O module, and thus to the real physical environment of the automation system.

The attestation may also be referred to as confirmation, as control session confirmation or as control session attestation. In this case, the term control session attestation arises in particular from the fact that the word component “session” relates to the authenticated communication connection and the word component “control” relates to the control possibility of the virtualized automation unit with regard to the I/O module and/or the actuator/sensor devices coupled to the I/O module. The attestation comprises in particular identification information of the specified I/O module and identification information of the specified virtualized automation unit. The respective identification information may be embodied for example in such a way that it comprises or references a respective authentication secret or authentication credential, for example a digital certificate or a cryptographic key, for example by way of a cryptographic hash value of the authentication credential used.

On the basis of the control session attestation, it is possible to carry out reliable and manipulation-protected checking that a specified virtualized automation unit actually has access to a specified real physical environment of the automation system via the specified I/O module. In some embodiments, this involves checking that a specified virtualized automation unit has access to a specified quantity of I/O modules of an automation system embodied as a cyber-physical system.

In some embodiments, the respective actuator/sensor device includes an actuator, a sensor, or an actuator and sensor device. The I/O module may also be referred to as input/output module and serves as an interface the for respectively coupled actuator/sensor devices. The computer system may also be referred to as computer platform, computer infrastructure, computing system or computing device. The computer system comprises in particular computing capacities and storage capacities. The computer system is coupled to the I/O modules via a network, which can comprise for example Ethernet, IP, mobile radio and WLAN. In the present case, the coupling by means of the network also comprises coupling of the units via different interconnected networks or subnetworks. Cryptographically protecting the attestation comprises in particular integrity protection, authenticity and/or confidentiality.

In some embodiments, a start-up functionality and/or a security autoconfiguration functionality, in particular onboarding and/or provisioning, of a machine of the automation system that is controlled by the specified virtualized automation unit are/is enabled depending on the authorization information, in particular enabled exclusively when the authorization information is present. In some embodiments, the start-up functionality and/or security autoconfiguration functionality are/is enabled in such a way that the start-up functionality and/or security autoconfiguration functionality are/is activated.

In some embodiments, the authorization information is adapted depending on the checking of the provided cryptographically protected attestation. Adapting the authorization information comprises in particular setting or granting the authorization information, deleting the authorization information and/or changing the authorization information with regard to specified access rights.

In some embodiments, adapting the authorization information comprises: registering the specified virtualized automation unit at the automation system, enabling an issuing of a digital certificate for the specified virtualized automation unit, and/or enabling an access for the specified virtualized automation unit to a specified database of the automation system and/or to a specified backend system of the automation system.

In some embodiments, adapting the authorization information comprises enabling the use of a specified cryptographic key in order for example to be able to decrypt encrypted formulations or manufacturing data of the automation system. The backend system is for example a SCADA system, a production planning system, a manufacturing execution system or a diagnostic system of the automation system.

In some embodiments, the first number of I/O modules and the actuator/sensor devices are arranged in a control network for controlling automation components of the automation network, and the computer system is arranged in a network superordinate to the control network, in particular a factory network.

In some embodiments, the cryptographically protected attestation comprises up-to-date status information for indicating an up-to-date status of the authenticated communication connection between the specified I/O module and the specified virtualized automation unit. The up-to-date status information comprises for example a time stamp, a counter value, a random value or a nonce value. The up-to-date status information thus indicates in particular a validity of the cryptographically protected attestation, in the negative case the lapsing of the attestation.

In some embodiments, a) comprises: issuing the attestation by way of the specified I/O module, and cryptographically protecting the issued attestation by way of the specified I/O module. The specified I/O module issues the attestation. It is the closest device to the connected actuator/sensor devices, and this thus affords the highest degree of security and manipulation protection with regard to the issuing and attestation.

In some embodiments, a) comprises: issuing the attestation by way of a component, in particular a hardware component, of the computer system, and cryptographically protecting the issued attestation by way of a component, in particular a hardware component, of the computer system. The component of the computer system is for example a communication stack, a network adapter or a runtime execution environment of the computer system on which the specified virtualized automation unit is executed.

In some embodiments, b) comprises checking a specified type of the access by the specified virtualized automation unit to the at least one portion of the actuator/sensor devices coupled to the specified I/O module. The respective type of access can be specified by different allocations of access rights. The type of access can comprise for example measurement by way of a specified sensor, influencing of the automation system by way of a specified actuator or a permissible value range of influencing of the real physical environment of the automation system.

In some embodiments, cryptographically protecting the attestation comprises the use of a digital signature, in particular the use of a digital signature specific to or issued for the attestation.

In some embodiments, b) is carried out repeatedly, in particular repeatedly according to a predetermined pattern, during ongoing operative operation of the automation system. The predetermined pattern stipulates a specified time duration, for example, after the elapsing of which checking is carried out repeatedly.

In some embodiments, a start-up functionality of a machine of the automation system that is controlled by the specified virtualized automation unit is enabled depending on the provided authorization information, in particular is enabled exclusively when the authorization information is present.

A machine of the automation system that is controlled or monitored by the virtualized automation unit starts for example only if, on the basis of the present attestation, checking has successfully revealed that this specified virtualized automation unit actually has access to the upstream I/O module of the machine and the machine.

In some embodiments, b) is carried out by a checking unit separate from the first number of I/O modules and from the computer system. The checking unit is in particular separate or separated from the I/O modules and the computer system and is for example part of a monitoring system of the automation system. In particular, the checking unit is coupled to the I/O modules and the computer system via one network or a plurality of networks.

In some embodiments, b) is carried out by the computer system.

In some embodiments, the attestation is embodied as an independent data structure which is protected by a cryptographic checksum. Examples thereof comprise an XML data structure and a JSON data structure.

In some embodiments, the attestation is embodied as a verifiable credential or as a verifiable presentation.

In some embodiments, a) is carried out for a multiplicity of authenticated communication connections between a respective I/O module and a respective automation unit for providing a multiplicity of cryptographically protected attestations. In this case, the multiplicity of provided cryptographic attestations are stored in a database, and checking is carried out using checking routines, the checking routines being formed by a stored procedure of the database or by a smart contract H distributed cryptographically protected transaction database. A distributed cryptographically protected transaction database may also be referred to as distributed ledger database or as blockchain infrastructure database.

In some embodiments, a computer program product causes one or more of the methods as described herein to be carried out on a program-controlled apparatus. A computer program product, such as e.g. a computer program means, can be provided or supplied for example as a storage medium, such as e.g. memory card, USB stick, CD-ROM, DVD, or else in the form of a downloadable file from a server in a network. This can be effected for example in a wireless communication network by way of the transmission of a corresponding file with the computer program product or the computer program means.

In some embodiments, there is a device for operating an automation system which comprises a first number of I/O modules and a computer system which is coupled to the first number of I/O modules via a network and has a second number of virtualized automation units. In this case, a respective number of actuator/sensor devices are coupled to the respective I/O module. The device comprises: a providing unit for providing a cryptographically protected attestation for indicating an authenticated communication connection between a specified I/O module of the first number and a specified virtualized automation unit of the second number, the authenticated communication connection comprising an authenticated communication between the specified virtualized automation unit and the specified I/O module and at least one portion of the actuator/sensor devices coupled to the specified I/O module, and a checking unit for checking the provided cryptographically protected attestation in order to determine authorization information depending on the access by the specified virtualized automation unit to the specified I/O module and/or to the at least one portion of the actuator/sensor devices coupled to the specified I/O module, said access being confirmed by the checked attestation.

The embodiments and features described for the proposed method apply, mutatis mutandis, to the proposed device. The respective unit, for example the providing unit or the checking unit, can be implemented in terms of hardware and/or else in terms of software. In the case of an implementation in terms of hardware, the respective unit can be embodied as a device or as part of a device, for example as a computer or as a microprocessor or as an integrated circuit. In the case of an implementation in terms of software, the respective unit can be embodied as a computer program product, as a function, as a routine, as part of a program code or as an executable object.

In some embodiments, an automation system is proposed. The automation system comprises a first number of I/O modules, a number of actuator/sensor devices being coupled to the respective I/O module, and a computer system which is coupled to the number of I/O modules via a network and has a second number of virtualized automation units, and a device for operating the automation system in accordance with the third aspect or in accordance with one of the embodiments of the third aspect.

Further possible implementations of the teachings herein also encompass not explicitly mentioned combinations of features or embodiments described above or below in regard to the exemplary environments. In this case, the person skilled in the art will also add individual aspects as improvements or supplementations to the respective embodiments described herein. In the figures, identical or functionally identical elements have been provided with the same reference signs, unless indicated otherwise.

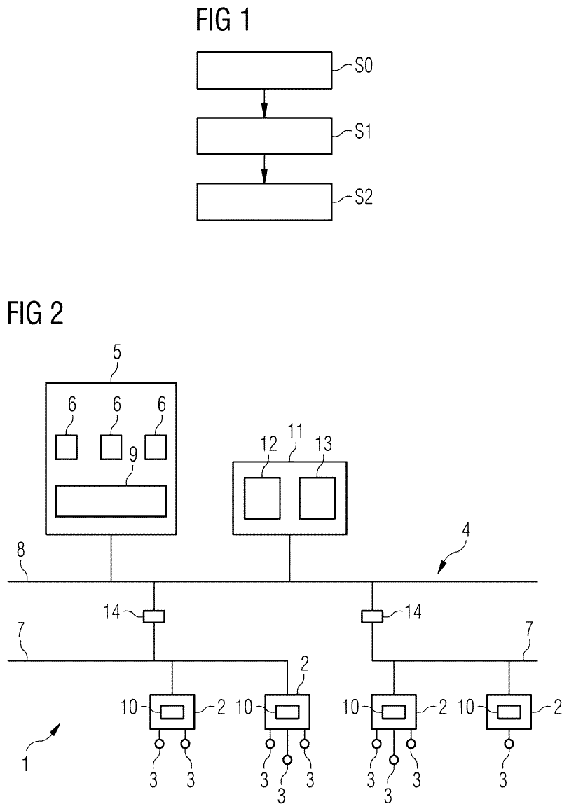

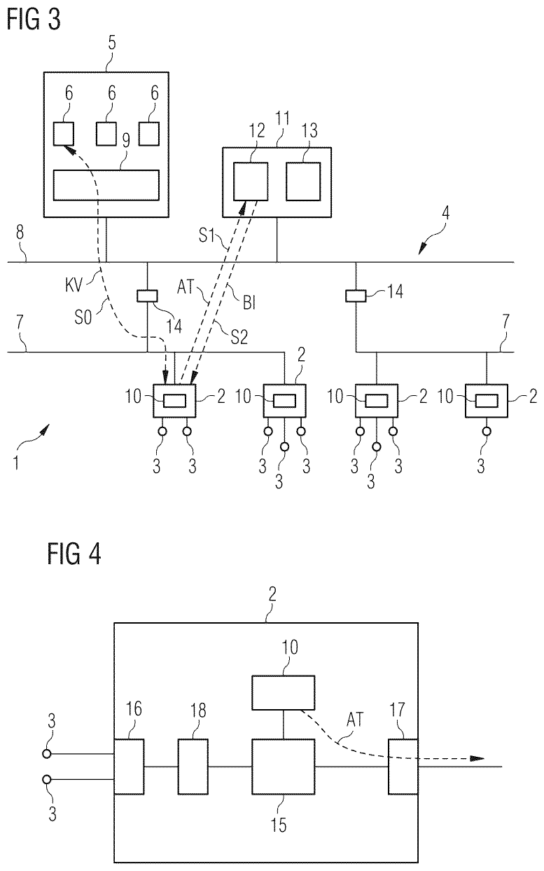

FIG. 1 shows a schematic flowchart of an example method for operating an automation system 1 incorporating teachings of the present disclosure. The exemplary embodiment according to FIG. 1 will be explained with reference to FIGS. 2 and 3. In this case, FIG. 2 shows a schematic block diagram of one exemplary embodiment of an automation system 1, and FIG. 3 shows the automation system 1 according to FIG. 2 with a depicted authenticated communication connection KV and depicted information flows AT, BI. The automation system 1 is suitable for example for producing a specified product, for example a motor vehicle or a chemical product, and has a plurality of automation components for this purpose. In this case, the automation system 1 according to FIGS. 2 and 3 has a first number, in particular a plurality, of I/O modules 2. A number of actuator/sensor devices 3 are coupled to the respective I/O module 2. The respective actuator/sensor device 3 is for example a sensor for sensing an element or an environment of the automation system 1, or an actuator for influencing at least one automation component of the automation system 1 or a sensor and actuator device.

As shown in FIGS. 2 and 3, the automation system 1 has two control networks 7 separated from one another, a number of I/O modules 2 being coupled to each of the control networks 7. Without restricting generality, the automation system 1 in FIGS. 2 and 3 has two control networks 7, two I/O modules 2 being coupled to each of the control networks 7. Furthermore, the automation system 1 according to FIGS. 2 and 3 has a factory network 8, which is hierarchically superordinate to the control networks 7. The control networks 7 are coupled to the factory network 8 via a respective gateway 14 and together form a network 4.

A computer system 5 is coupled to the factory network 8. The computer system 5 in FIGS. 2 and 3 comprises a number, in particular a plurality, of virtualized automation units 6. Without restricting generality, the computer system 5 in FIGS. 2 and 3 has three virtualized automation units 6. Moreover, the computer system 5 in FIGS. 2 and 3 comprises an execution environment 9 for coupling the virtualized automation units 6. The execution environment 9 (also referred to as runtime environment) is suitable for executing the virtualized automation functions 6 on the computer system 5. In particular, the execution environment 9 is suitable for executing the virtualized automation units 6 on the computer system 5 and for providing or enabling authenticated, cryptographically protected data transfer sessions between virtualized automation units 6 and I/O modules 2. In some embodiments, the execution environment 9 is embodied as a real-time environment. Furthermore, a monitoring system 11 is coupled to the factory network 8 in FIGS. 2 and 3. The monitoring system 11 has a checking unit 12 and a storage unit 13.

Turning now to the flowchart according to FIG. 1, which comprises S0, S1 and S2. Step S0 involves setting up an authenticated communication connection KV between a specified I/O module 2 and a specified virtualized automation unit 6. As shown in FIG. 3, this authenticated communication connection KV is set up for example between the virtualized automation unit 6 arranged on the far left and the I/O module 2 arranged on the far left.

Step S1 involves providing a cryptographically protected attestation AT for indicating the authenticated communication connection KV between the specified I/O module 2 and the specified virtualized automation unit 6. In this case, the authenticated communication connection KV comprises an authenticated communication between the specified virtualized automation unit 6 and the specified I/O module 2 and the actuator/sensor devices 3 coupled to the specified I/O module 2. In FIG. 3, these devices are the two actuator/sensor devices 3 arranged on the far left. In the example in FIG. 3, the attestation AT is issued by the specified I/O module 2 which has the authenticated communication connection KV to the specified virtualized automation unit 6. For this purpose, as shown in FIGS. 2 and 3, the respective I/O module 2 has a respective providing unit 10. The providing unit 10 is suitable for issuing and then cryptographically protecting the attestation AT. The cryptographically protected attestation AT comprises in particular an up-to-date status information for indicating an up-to-date status of the authenticated communication connection KV between the specified I/O module 2 and the specified virtualized automation unit 6.

In some embodiments, the attestation AT can also be issued by a component of the computer system 5 (not shown in FIGS. 2 and 3). It is then also this component of the computer system 5 which cryptographically protects the issued attestation AT and thus provides a cryptographically protected attestation AT. In accordance with FIG. 3, the provided cryptographically protected attestation AT is transmitted to the monitoring system 11 via the network 4 comprising the control network 7 and the factory network 8. This providing and transmitting of the cryptographically protected attestation AT from the specified I/O module 2 in FIG. 3 to the monitoring system 11 is illustrated in FIG. 3 by the arrow depicted with the reference sign S1 (for the method step) and the reference sign AT for the attestation.

S2 involves checking the provided cryptographically protected attestation AT in order to determine authorization information BI depending on the access confirmed by the checked attestation AT. In the example in FIG. 3, this checking is carried out by the checking unit 12 of the monitoring system 11. The authorization information BI specifies the access by the specified virtualized automation unit 6 to the specified I/O module 2 and/or to one or both actuator/sensor devices 3 coupled to the specified I/O module 2 in FIG. 3.

In particular, the authorization information BI can be adapted depending on the checking of the provided cryptographically protected attestation AT. This adapting of the authorization information BI can comprise: registering the specified virtualized automation unit 6 at the automation system 1, enabling an issuing of a digital certificate for the specified virtualized automation unit 6, and/or enabling an access for the specified virtualized automation unit 6 to a specified database of the automation system 1 (not shown) and/or to a specified backend system of the automation system 1 (not shown).

In some embodiments, the checking unit 12 is also configured to check a specified type of the access by the specified virtualized automation unit 6 to the at least one portion of the actuator/sensor devices 3 coupled to the specified I/O module 2. By way of example, a start-up functionality of a machine of the automation system 1 that is controlled by the specified virtualized automation unit 6 is enabled depending on the provided authorization information BI, in particular is enabled exclusively when the authorization information BI is present. In this case, enabling the start-up functionality can also comprise activating the start-up functionality. In further exemplary embodiments, not specifically illustrated, which moreover correspond to the illustrated exemplary embodiment, not just the start-up functionality of the machine is enabled, but rather alternatively or additionally a security autoconfiguration functionality of the machine, for example onboarding and/or provisioning of the machine. The attestation AT is embodied in particular as an independent data structure. Examples thereof comprise an XML data structure or a JSON data structure. This independent data structure may then protected by a cryptographic checksum in order to form the cryptographically protected attestation AT. The attestation AT can also be embodied as a verifiable credential or as a verified presentation.

S1 is carried out in particular for a multiplicity of authenticated communication connections KV between a respective I/O module 2 and a respective virtualized automation unit 6 for providing a multiplicity of cryptographically protected attestations AT. This multiplicity of provided cryptographic attestations AT is stored in a database or storage unit 13, and step S2 of checking is carried out using checking routines, which in particular are likewise stored in the storage unit 13. In this case, these checking routines are preferably formed by a stored procedure of the storage unit 13 or by a smart contract of a distributed cryptographically protected transaction database (not shown).

In some embodiments, S1 and S2 in FIG. 1 are carried out repeatedly, in particular repeatedly according to a predetermined pattern, in particular during ongoing operative operation of the automation system 1. In addition to this authorization check which involves checking the attestation AT so as to determine whether a specified virtualized automation component can currently access specified I/O modules 2 and/or specified actuator/sensor devices 3 coupled to an I/O module 2, further authorization checks can take place (not shown), e.g. a check of an access control list.

FIG. 4 illustrates a schematic block diagram of an example I/O module 2 incorporating teachings of the present disclosure. The I/O module 2 in FIG. 4 comprises a providing unit 10 for providing a cryptographically protected attestation AT (see also FIGS. 2 and 3), a communication unit 15, an interface unit 16 for linking the actuator/sensor devices 3, a network interface 17 for coupling to the network 4 and a processing unit 18 coupled between the communication unit 15 and the interface unit 16. The communication unit 15 is suitable for providing a secure communication, in particular for setting up authenticated communication connections KV. For this purpose, the communication unit 15 can have a first module for network traffic encryption and decryption, and a second module for authentication and key agreement.

The processing unit 18 is configured for processing control commands from and to the actuator/sensor devices 3. As illustrated in FIG. 4, the providing unit 10 can provide and cryptographically protect the attestation AT and then provide it as a cryptographically protected attestation via the network interface 17 via the network 4, in particular to the monitoring system 11 (see FIG. 3). For this purpose, the providing unit 10 can have an attestation unit for issuing the attestation and an encryption unit for cryptographically protecting the issued attestation. In this case, an attestation key stored in the I/O module 2 can be used, in particular. The encryption unit for cryptographically protecting the issued attestation can form for example a digital signature or a message authentication code of the attestation, or it can form a verifiable credential corresponding to the attestation or a verifiable presentation corresponding to the attestation, or it can transmit the attestation via a cryptographically protected transmission channel.

As shown in FIG. 4, the actuator/sensor devices 3 can be external to the I/O module 2. In some embodiments, at least one of the actuator/sensor devices 3 can also be integrated in the I/O module 2. The present attestation AT provides cryptographically protected confirmation of which authenticated communication partner of the I/O module 2, the virtualized automation unit 6 illustrated on the far left in the example in FIG. 3, currently actually has access to the I/O module 2 as a whole or to specified actuator/sensor devices 3 of the I/O module 2 or to a specified actuator/sensor device 3. In this case, it is possible for individual interfaces for the actuator/sensor devices 3 of the interface unit 16 to be identified by a dedicated identifier contained in the attestation AT, or for an individual connected actuator/sensor device 3 to be identified.

For this purpose, it is possible to use an explicit identifier or a digital fingerprint of the actuator/sensor device 3 determined by way of the I/O module 2, or on the basis of calibration data or configuration data assigned to the actuator/sensor device 3. Consequently, an authorization can also be adapted if there is no access to a specified, correctly configured and calibrated actuator/sensor device 3.

Although the teachings of the present disclosure have been described on the basis of exemplary embodiments, it is modifiable in diverse ways.

What is claimed is:

1. A method for operating an automation system including a first number of I/O modules, a number of actuator/sensor devices coupled to the respective I/O module, a computer system coupled to the number of I/O modules via a network, and a second number of virtualized automation units, the method comprising:
a) providing a cryptographically protected attestation for indicating an authenticated communication connection between a specified I/O module of the first number and a specified virtualized automation unit of the second number, the authenticated communication connection comprising an authenticated communication between the specified virtualized automation unit and the specified I/O module and at least one portion of the actuator/sensor devices coupled to the specified I/O module; and
b) checking the provided cryptographically protected attestation in order to determine authorization information depending on the access by the specified virtualized automation unit to the specified I/O module and/or to the at least one portion of the actuator/sensor devices coupled to the specified I/O module, said access being confirmed by the checked attestation.

2. The method as claimed in claim 1, further comprising adapting the authorization information based on the checking of the provided cryptographically protected attestation.

3. The method as claimed in claim 2, wherein adapting the authorization information comprises:
registering the specified virtualized automation unit at the automation system;
enabling an issuing of a digital certificate for the specified virtualized automation unit; and/or
enabling an access for the specified virtualized automation unit, to a specified database of the automation system and/or to a specified backend system of the automation system.

4. The method as claimed in claim 1, wherein;
the first number of I/O modules and the actuator/sensor devices are arranged in a control network for controlling automation components of the automation network; and
the computer system is arranged in a network superordinate to the control network.

5. The method as claimed in claim 1, wherein the cryptographically protected attestation comprises up-to-date status information for indicating an up-to-date status of the authenticated communication connection between the specified I/O module and the specified virtualized automation unit.

6. The method as claimed in claim 1, wherein a) comprises:
issuing the attestation by way of the specified I/O module; and
cryptographically protecting the issued attestation by way of the specified I/O module.

7. The method as claimed in claim 1, wherein a) comprises:
issuing the attestation by way of a component, of the computer system; and
cryptographically protecting the issued attestation by way of a component, of the computer system.

8. The method as claimed in claim 1, wherein b) comprises
checking a specified type of the access by the specified virtualized automation unit to the at least one portion of the actuator/sensor devices coupled to the specified I/O module.

9. The method as claimed in claim 1, wherein b) is carried out repeatedly during ongoing operative operation of the automation system.

10. The method as claimed in claim 1, wherein a start-up functionality of a machine of the automation system is controlled by the specified virtualized automation unit is enabled depending on the provided authorization information enabled exclusively when the authorization information is present.

11. The method as claimed in claim 1, wherein b) is carried out by a checking unit separate from the first number of I/O modules and from the computer system.

12. The method as claimed in claim 1, wherein:
the attestation comprises an independent data structure protected by a cryptographic checksum; or
the attestation comprises a verifiable credential or a verifiable presentation.

13. The method as claimed in claim 1, wherein:
a) is carried out for a multiplicity of authenticated communication connections between a respective I/O module and a respective virtualized automation unit for providing a multiplicity of cryptographically protected attestations, the multiplicity of provided cryptographically protected attestations stored in a database; and
b) checking is carried out using checking routines, the checking routines being formed by a stored procedure of the database or by a smart contract of a distributed cryptographically protected transaction database.

14. (canceled)

15. A device for operating an automation system including a first number of I/O modules, a number of actuator/sensor devices being coupled to the respective I/O module, a computer system which is coupled to the number of I/O modules via a network and has a second number of virtualized automation units, the device comprising:
a providing unit to provide a cryptographically protected attestation for indicating an authenticated communication connection between a specified I/O module of the first number and a specified virtualized automation unit of the second number, the authenticated communication connection comprising an authenticated communication between the specified virtualized automation unit, and the specified I/O module and at least one portion of the actuator/sensor devices coupled to the specified I/O module; and
a checking unit to check the provided cryptographically protected attestation to determine authorization information depending on the access by the specified virtualized automation unit to the specified I/O module and/or to the at least one portion of the actuator/sensor devices coupled to the specified I/O module, said access being confirmed by the checked attestation.

16. An automation system comprising:
a first number of I/O modules;
a number of actuator/sensor devices coupled to the respective I/O module;
a computer system coupled to the number of I/O modules via a network and has a second number of virtualized automation units; and
a device for operating the automation system comprising:
providing unit to provide cryptographically protected attestation for indicating an authenticated communication connection between a specified I/O module of the first number and a specified virtualized automation unit of the second number, the authenticated communication connection comprising an authenticated communication between the specified virtualized automation unit and the specified I/O module and at least one portion of the actuator/sensor devices coupled to the specified I/O module; and
a checking unit to check the provided cryptographically protected attestation to determine authorization information depending on the access by the specified virtualized automation unit to the specified I/O module and/or to the at least one portion of the actuator/sensor devices coupled to the specified I/O module, said access being confirmed by the checked attestation.
